(19) United States
(12) Patent Application Publication
(10) Pub. No.: US 2022/0162766 A1
(43) Pub. Date: May 26, 2022

(54) Coated Metal Alloy Substrate with at least one Chamfered Edge and Process for Production Thereof

(71) Applicant: Hewlett-Packard Development Company, L.P., Spring, TX (US)

(72) Inventors: Kuan-Ting Wu, Taipei City (TW); Chi Hao Chang, Taipei City (TW); Hslng-Hung Hsieh, Taipei City (TW)

(73) Assignee: Hewlett-Packard Development Company, L.P., Spring, TX (US)

(21) Appl. No.: 17/296,784

(22) PCT Filed: Aug. 14, 2019
(86) PCT No.: PCT/US2019/046463

§ 371 Date: May 25, 2021

(51) Int. Cl. C25D 13/06; C25D 13/20

(52) U.S. Cl. CPC C25D 13/06; C25D 13/20

(57) ABSTRACT

A coated metal alloy substrate with at least one chamfered edge, a process for producing a coated metal alloy substrate, and an electronic device having a housing comprising a coated metal alloy substrate are described. The coated metal alloy substrate with at least 10 one chamfered edge comprises a water transfer print layer deposited on the metal alloy substrate, a passivation layer deposited on the at least one chamfered edge, and an electrophoretic deposition layer deposited on the passivation layer.

Electronic devices, such as laptops and mobile phones, include various components located within a metal alloy housing. Such metal alloy housings are made of metal alloy substrates that provide sought after metallic lustre of the metal alloy enclosure. Such enclosures should be able to withstand wear and tear from regular use and exposure to the natural environment.

### BRIEF DESCRIPTION OF THE FIGURES

FIG. 1 is a flow chart showing an example of a process for producing a coated metal alloy substrate.

FIG. 2 is a flow chart showing an example of a process for producing a coated metal alloy substrate comprising the formation of a first layered surface.

FIG. 3 is a partial cross-section diagram showing an example of a coated metal alloy substrate.

FIG. 4 shows an example housing for a laptop.

The figures depict several examples of the present disclosure. It should be understood that the present disclosure is not limited to the examples depicted in the figures.

### DETAILED DESCRIPTION

Before the coated metal alloy substrate, process for producing a coated metal alloy substrate, and electronic device with a housing comprising a coated metal alloy substrate are disclosed and described, it is to be understood that this disclosure is not limited to the particular process details and materials disclosed herein because such process details and materials may vary somewhat. It is also to be understood that the terminology used herein is used for the purpose of describing particular examples. The terms are not intended to be limiting because the scope of the present disclosure is intended to be limited by the appended claims and equivalents thereof.

It is noted that, as used in this specification and the appended claims, the singular forms “a”, “an” and “the” include plural referents unless the context clearly dictates otherwise.

If a standard test is mentioned herein, unless otherwise stated, the version of the test to be referred to is the most recent at the time of fling this patent application.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

Concentrations, amounts, and other numerical data may be expressed or presented herein in a range format. It is to be understood that such a range format is used merely for convenience and brevity and thus should be interpreted flexibly to include the numerical values explicitly recited as the limits of the range and also to include all the individual numerical values or sub-ranges encompassed within that range as if each numerical value and sub-range is explicitly recited. As an illustration, a numerical range of “about 1 wt. % to about 5 wt. %” should be interpreted to include the explicitly recited values of about 1 wt. % to about 5 wt. % and also include individual values and subranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list based on their presentation in a common group without indications to the contrary.

As used herein, the term “deposited” when used to refer to the location or position of a layer includes the term “disposed” or “coated”.

As used herein, the term “engraving” when used to refer to the formation of a chamfered edge includes the term “etching” or “cutting”.

As used herein, the term “comprises” has an open meaning, which allows other, unspecified features to be present. This term embraces, but is not limited to, the semi-closed term “consisting essentially of” and the closed term “consisting of”. Unless the context indicates otherwise, the term “comprises” may be replaced with either “consisting essentially of” or “consists of”.

Unless otherwise stated, any feature described herein can be combined with any aspect or any other feature described herein.

Coated Metal Alloy Substrate

In some examples there is provided a coated metal alloy substrate for an electronic device, wherein the coated metal alloy substrate comprises at least one chamfered edge and comprises: a water transfer print layer deposited on the metal alloy substrate; a passivation layer deposited on the at least one chamfered edge; and an electrophoretic deposition layer deposited on the passivation layer.

Metal Alloy Substrate

The metal alloy substrate may comprise a metal selected from aluminium, magnesium, lithium, titanium, niobium, zinc and alloys thereof. For example, the metal alloy substrate may comprise a metal alloy selected from an aluminium alloy, a magnesium alloy, a lithium alloy, a titanium alloy and stain steel. These metals may be light-weight and can provide a durable housing.

Generally, the metal alloy comprises a content of metal of at least about 75 wt. %. For example, when the metal alloy is a magnesium alloy, the magnesium alloy may comprise at least about 80 wt. % magnesium, or at least 85 wt. % magnesium, or at least about 90 wt. % of magnesium, based on the total weight of the metal alloy.

The magnesium alloy may further comprise aluminium, zinc, manganese, silicon, copper, a rare earth metal or zirconium. The aluminium content may be about 2.5 wt. % to about 13.0 wt. %. When the magnesium alloy comprises aluminium, then at least one of manganese, zirconium, or silicon is also present. Examples of magnesium alloys include AZ31, AZ31B, AZ81, AZ60, AZ80, AM60, AZ91D, LZ91, LZ14, ALZ691 alloys according to the American Society for Testing Materials standards.

In one example, the metal alloy comprises the components, based on the total weight of the metal alloy, Al: 0.02 wt. % to 9.7 wt. %, Zn: 0.02 wt. % to 1.4 wt. %, Mn: 0.02 wt. % to 0.5 wt. %, one or more component selected from Si: 0.02 wt. % to 0.1 wt. %, Fe: 0.004 wt. % to 0.05 wt. %, Ca: 0.0013 wt. % to 0.04 wt. %, Ni: 0.001 wt. % to 0.005 wt. %, Cu: 0.008 wt. % to 0.05 wt. %, Li: 9.0 wt. % to 14.3 wt. %, Zr up to 0.002 wt. % and the balance being Mg and inevitable impurities.

Insert Molded Meta Substrate

The metal alloy substrate may be an insert molded metal substrate to form a metal substrate with sections comprising a further material, such as plastics. For example, the insert molded metal substrate may be formed by using the metal substrate as a mold. This metal mold may have a section into which a material, such as plastic, is injected to form a plastic insert. Plastics used for insert molded metal substrates may be selected from polybutylene terephthalate (PBT), polyphenylene sulfide (PPS), polyamide (nylon), polyphthalamide (PPA), acrylonitrile butadiene styrene (ABS), polyetheretherketone (PEEK), polycarbonate (PC) and acrylonitrile butadiene styrene with polycarbonate (ABS/PC) with 15 to 50 wt. % glass fibre filler.

Chamfered Edge

The metal alloy substrate comprises at least one chamfered edge. The chamfered edge is formed by engraving the metal alloy substrate. The engraving process to form a chamfered edge can be carried out using a range of techniques including a computer numeric control (CNC) diamond cut or laser engraving process. The engraving process exposes a non-oxidized surface of the substrate. The non-oxidized surface of the substrate exposed in this way is an uncoated surface of the substrate that has not undergone substantial oxidation, so that, for example, it retains its metallic appearance.

By coating the non-oxidised surface of the metal alloy substrate formed by engraving with a passivation layer and an electrophoretic deposition layer, it may be possible to both protect and retain the attractive, shiny appearance of the underlying metallic substrate. Unlike coatings formed by electroplating processes, the layer can protect the exposed, underlying surface from corrosion. The coated chamfered edges disclosed herein can show good resistance as tested using a salt fog test, such as ASTM B117, particularly when compared to coating formed by electroplating.

Water Transfer Print Laver

The water transfer print layer is applied using a water transfer print film. The water transfer print film may be used to apply an image onto the metal alloy substrate. The water transfer print film may comprise an image printed on a water-soluble film. The printed image may be printed, for example, gravure printed with an image. The water transfer print layer may bear any graphic image.

The water transfer print film may comprise a water-soluble polymer. For example, the water transfer print film may comprise polyvinyl alcohol (PVA).

To transfer the image onto the metal alloy substrate, the water transfer print film is placed on the surface of a body of water. An activator solution may be applied to the water transfer print film to initiate dissolution of the water-soluble film. This leaves the printed ink on the surface of the water. When the metal alloy substrate is dipped into the water comprising the printed ink, the surface tension of the water allows the ink to conform and adhere to the surface of the substrate. Thus, the printed ink may be transferred onto the metal alloy substrate as a water transfer print layer.

Any suitable activator solution may be employed. For example, the activator solution may comprise an organic solvent selected from xylene propylene glycol, isobutyl alcohol, isopropyl alcohol, n-butyl alcohol, methyl ethyl ketone, methyl isobutyl ketone, 3-methoxy-3-methyl-1-butyl acetate, ethyl acetate, butyl acetate, propylene glycol monomethyl ether, ethylene glycol monobutyl ether and combinations thereof. The activator solution may comprise an organic solvent in an amount of from about 10 to about 80 wt. %, or from about 20 to about 70 wt. %, or from about 30 to about 60 wt. %, or from about 40 to about 50 wt. %, in deionised water, based on the total weight of the activator solution.

An image may be transferred as a water transfer print layer onto a primer coating layer on the metal alloy substrate. The primer coating layer may assist adhesion of the water transfer print layer onto the metal alloy substrate. The water transfer print layer may be in contact with at least part of the primer coating layer. For example, the water transfer print layer may be in direct contact with at least part of the primer coating layer.

Passivation Layer

The passivation layer may be transparent. The passivation layer may comprise a chelating agent and a metal ion or chelated metal complex thereof, or a mixture of the chelating agent, the metal ion and the chelated metal complex. The chelated metal complex comprises a ligand coordinated to the metal ion. The ligand is the chelating agent.

The chelating agent may be selected from ethylenediaminetetraacetic acid (EDTA), ethylenediamine (EN), nitrilotriacetic acid (NTA), diethylenetriaminepenta(methylenephosphonic acid) (DTPPH), nitrilotris(methylenephosphonic acid) (NTMP), 1-hydroxyethane-1,1-diphosphonic acid (HEDP) and phosphoric acid. In one example, the chelating agent is DTPPH.

The metal ion is selected from an aluminium ion, a nickel ion, a chromium ion, a tin ion, an indium ion, and a zinc ion. In one example, the metal ion is selected from an aluminium ion, a nickel ion and a zinc ion.

In one example, the chelated metal complex may comprise DTPPH chelated to an aluminium ion. In another example, the chelated metal complex may comprise DTPPH chelated to a nickel ion. In a further example, the chelated metal complex may comprise DTPPH chelated to a zinc ion.

The passivation layer may have a thickness of from about 30 nm to about 3 μm, such as from about 200 nm to about 2 μm, or from about 500 nm to about 1 μm.

The passivation layer is deposited on the chamfered edge or edges. In one example, the passivation layer may also be deposited on the water transfer print layer of the metal alloy substrate.

Electrophoretic Deposition Layer

The electrophoretic deposition layer comprises an electrophoretic polymer selected from polyacrylic polymer, polyacrylamide-acrylic copolymer and epoxy-containing polymer.

The electrophoretic deposition layer may be transparent. In one example, the electrophoretic deposition layer is colourless. In another example, the electrophoretic polymer layer may comprise a colorant.

A ‘colorant’ may be a material that imparts a colour to the electrophoretic deposition layer. As used herein, “colorant” includes pigments and dyes, such as those that impart colours, such as black, magenta, cyan, yellow and white to an electrophoretic deposition layer. The pigment particles may be dispersed throughout the electrophoretic deposition layer. The pigment may be selected from carbon black, titanium dioxide, clay, mica, talc, barium sulfate, calcium carbonate, synthetic pigment, pearl pigment, metallic powder, aluminium oxide, dye, graphene, graphite, pigment colorants, magnetic particles and an inorganic powder. Although the present description primarily exemplifies the use of pigment colorants, the term “pigment” can be used more generally to describe pigment colorants and also other pigments such as organometallics, ferrites and ceramics. In one example, the pigment is a dye. The dye may be dispersed throughout the electrophoretic deposition layer.

The colorant can be any colorant compatible with the electrophoretic polymer and useful for providing an electrophoretic deposition layer. For example, the colorant may be present as pigment particles, or may comprise a resin and a pigment. The pigments can be any of those standardly used in the art. In some examples, the colorant is selected from a cyan pigment, a magenta pigment, a yellow pigment and a black pigment. For example, pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, Pigment Yellow 191, CROMOPHTHAL® YELLOW GR, CROMOPHTHAL® YELLOW 8 G, IRGAZINE® YELLOW SGT, IRGALITE® RUBINE 48L, MONASTRAL® MAGENTA, MONASTRAL® SCARLET, MONASTRAL® VIOLET, MONASTRAL® RED, Pigment Red 168 MF, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200. If the pigment is a white pigment particle, the pigment particle may be selected from TiO2, calcium carbonate, zinc oxide, and mixtures thereof. In some examples, the white pigment particle may comprise an alumina-TiO2 pigment. In some examples, the colorant may be a red dye, or a blue dye or an orange dye or a yellow dye such Alexa Fluor 594 dye, or Texas Red, or Pacific Blue dye, or Pacific Orange, or Quinoline Yellow WS.

The colorant or pigment may be present in the electrophoretic deposition layer in an amount of from about 0.3 wt. % to about 30 wt. %, based on the total weight of the electrophoretic deposition layer. For example, the colorant or pigment may be present in the electrophoretic deposition layer in an amount from about 0.5 wt. % to about 25 wt. %, or from about 3 wt % to about 22 wt. %, or from about 5 wt. % to about 20 wt. %, or from about 6 wt. % to about 18 wt. %, or from about 8 wt. % to about 15 wt. %, or from about 10 wt. % to about 12 wt. %, based on the total weight of the electrophoretic deposition layer.

In some examples, the colorant or pigment particle may be present in the electrophoretic deposition layer in an amount of at least 10 wt. % based on the total weight of the electrophoretic deposition layer, for example at least 12 wt % based on the total weight of the electrophoretic deposition layer.

In one example the electrophoretic deposition layer comprises, based on the total weight of the electrophoretic deposition layer, 10 wt % polyacrylic copolymer resin, 1 wt. % titanium dioxide, 0.5 wt. % glutaraldehyde, 0.3 wt. % of an anionic surfactant, such as sodium dodecylbenzene, and 88.2 wt % de-ionized water.

The electrophoretic polymer layer may have a thickness of from about 5 μm to about 60 μm, for example from about 10 μm to about 55 μm, or from about 15 pmto about 50 μm, or from about 20 μm to about 45 μm, or from about 25 μm to about 40 μm, or from about 30 μm to about 35 μm.

Pre-Treatment of the Metal Alloy Substrate

The metal alloy substrate may be pre-treated to form a first layered surface before formation of the chamfered edge, which includes application of the water transfer print layer, as shown, for example, in FIG. 2. The first layered surface may comprise a single layer or a combination of layers. The first layered surface may comprise an oxidized layer or a protective layer. The first layered surface may comprise a water transfer print layer.

When the first layered surface comprises an oxidized layer, this layer may comprise a preliminary passivation layer, an oxidized layer of the metallic substrate, or both an oxidized layer of the metallic substrate and a preliminary passivation layer. The preliminary passivation layer may also be referred to herein as an inorganic layer.

The inorganic layer may comprise a salt selected from a molybdate salt, a vanadate salt, a phosphate salt, a chromate salt, a stannate salt and a manganese salt. In one example, the inorganic layer comprises a phosphate salt. The inorganic layer may contain oxidic salts that can provide the first surface with a dark grey appearance. In one example, the inorganic layer may be non-transparent.

The oxidized layer of the metallic substrate may be a micro-arc oxide (MAO) layer, such as a micro-arc oxide layer of the magnesium alloy. For example, when the substrate comprises a magnesium alloy, the oxidized layer of the metallic substrate is an oxidized layer of the magnesium alloy. The micro-arc oxide layer may be obtainable from the method described herein.

The oxidized layer of the metallic substrate, including the micro-arc oxide layer, can have a thickness of from about 3 μm to about 15 μm, such as from about 5 μm to about 12 μm, from about 7 μm to about 10 μm. The inorganic layer may have a thickness of from about 0.5 μm to about 5 μm, such as from about 1 μm to about 4 μm, or about 2 μm to about 3 μm.

In one example, both an oxidized layer of the metallic substrate and an inorganic layer may be present. In one example, the inorganic layer can be deposited or coated on the surface of the metal alloy substrate.

In one example, the oxidized layer or the inorganic layer can be a single layer, wherein the oxidized layer is a micro-arc oxide layer. By itself, the micro-arc oxide layer or the passivation layer may prevent corrosion of the metal alloy substrate.

To form a first layered surface, the metal alloy substrate may be treated to form an oxidized layer. The oxidized layer may comprise an oxidized layer of the metallic substrate. The oxidized layer may comprise a micro-arc oxide layer, such as a micro-arc oxide layer of the metal alloy. The micro-arc oxide layer is prepared by micro-arc oxidation of the substrate.

Micro-arc oxidation (MAO) is an electrochemical oxidation process that can, for example, generate an oxidized layer on a metallic substrate, such as a substrate comprising a metal alloy. MAO involves creating micro-discharges on a surface of the metal alloy immersed in an electrolyte to produce a crystalline oxide coating. The resulting micro-arc oxide layer may be ductile and have a relatively high hardness. Unlike anodizing processes, MAO employs a high potential such that discharges occur. The resulting plasma can modify the structure of the oxide layer. MAO is a chemical conversion process that causes oxidation of the underlying metal alloy material, instead of an oxide layer being disposed on to a surface of the metal alloy. This may lead to a metal surface with enhanced wear and corrosion resistance and may prolong the component lifetime. In comparison to an oxide layer produced by a deposition process, a micro-arc oxide layer may have a higher adhesion to the underlying metal alloy.

The electrolytic solution for MAO may comprise an electrolyte selected from sodium silicate, sodium phosphate, potassium fluoride, potassium hydroxide, sodium hydroxide, fluorozirconate, sodium hexametaphosphate, sodium fluoride aluminium oxide, silicon dioxide, ferric ammonium oxalate, a salt of phosphoric acid, polyethylene oxide alkylphenolic ether and a combination thereof.

One or more protective layers may then applied to the oxidized layer. Each of these layers may be sprayed, rollered, dipped, or brushed onto the metal alloy surface.

The first layered surface may further comprise at least one protective layer, such as two, three or four protective layers. Each protective layer may be independently selected from a primer coating layer, a top coating layer, a base coating layer and powder coating layer. The protective layer may be deposited or coated directly onto the oxidized layer or the inorganic layer. Each of these protective layers may be made of different materials and may provide different functionality, such as heat resistance, hydrophobicity, and anti-bacterial properties. In one example, a protective layer may be a primer coating layer. For example, the primer coating layer may be deposited or coated directly onto the oxidized layer or the inorganic layer before applying the water transfer printing layer. The use of a primer coating layer before applying the water transfer layer may enhance the adhesion of the water transfer printing layer. The use of a top coating layer can provide good protection on the surface of water transfer printing layer. The top coating layer may also offer the different touch feeling features such as anti-fingerprint, glossy or matt surface finishes.

The primer coating layer may comprise a polyurethane or a filler selected from carbon black, titanium dioxide, clay, mica, talc, barium sulfate, calcium carbonate, a synthetic pigment, a metallic powder, aluminium oxide, carbon nanotubes (CNTs), graphene, graphite, and an organic powder. The organic powder may, for example, be an acrylic, a polyurethane, a polyamide, a polyester or an epoxide. The primer coating layer may, for example, comprise a polyurethane and a filler as described above.

A heat resistant material may be included in the primer coating layer. In an example, the primer coating layer contains a heat resistant material, a filler as described above and may further comprise a polyurethane.

The primer coating layer can have a thickness of from about 5 μm to about 20 μm, such as from about 7 μm to about 18 μm, or from about 10 μm to about 15 μm.

A top coating layer may be deposited on the water transfer print layer. The top coating layer may comprise a bottom layer and a top layer coated or deposited on the bottom layer. The bottom layer may comprise a polyurethane polymer. The top layer may comprise a UV top coat. The UV top coat may, for example, be a resin, such as a polyacrylic resin, a polyurethane resin, a urethane acrylate resin, an acrylic acrylate resin or an epoxy acrylate resin.

When the top coating layer comprises a bottom layer and a top layer, then both the bottom layer and the top layer may be transparent. The top coating layer may be transparent.

The top coating layer can have a total thickness of from about 10 μm to about 25 μm, such as about 15 μm to about 20 μm.

The base coating layer may comprise polyurethane-containing pigments. The base coating layer may further comprise at least one of carbon black, titanium dioxide, clay, mica, talc, barium sulfate, calcium carbonate, synthetic pigment, metallic powder, aluminium oxide, an organic powder, an inorganic powder, graphene, graphite, plastic beads, a colour pigment or a dye. The organic powder may, for example, be an acrylic, a polyurethane, a polyamide, a polyester or an epoxide.

The base coating layer may comprise a component selected from barium sulfate, talc, a dye and a colour pigment. In one example, the base coating layer comprises a colour pigment or a dye.

The base coating layer may further comprise a heat resistant material, such as a silica aerogel. The base coating layer can comprise a heat resistant material and a component as described above.

The base coating layer can have a thickness of from about 10 μm to about 25 μm, such as from about 15 μm to about 20 μm.

By using a base coating layer, other different protective layers can easily be deposited on the first layered surface. For example, when the first layered surface has been coated with an oxide layer, the use of a base coating layer may improve adhesion between different protective layers.

The powder coating layer may comprise a polymer selected from an epoxy resin, a poly(vinyl chloride), a polyamide, a polyester, a polyurethane, an acrylic and a polyphenylene ether.

In an example, the powder coating layer is an electrostatic powder coating layer. The powder coating layer may be electrostatically deposited or coated onto a first surface of the substrate and then the polymer may be cured.

The powder coating layer may further comprise a filler selected from carbon black, titanium dioxide, clay, mica, talc, barium sulfate, calcium carbonate, a synthetic pigment, a metallic powder, aluminium oxide, carbon nanotubes (CNTs), graphene, graphite, and an organic powder. The organic powder may, for example, be an acrylic, a polyurethane, a polyamide, a polyester or an epoxide. In one example, the fillers may be selected from talc, clay, graphene and high aspect ratio pigments.

The powder coating layer may be applied and may be cured at a temperature of 120° C. to 190° C.

The powder coating layer can have a thickness of from about 20 μm to about 60 μm, such as from about 30 μm to about 50 μm, or from about 35 μm to about 45 μm.

The first layered surface of the metal alloy substrate may then be engraved to expose a non-oxidized chamfered edge on the metal alloy substrate. This process may remove part of the first layered surface that was previously applied.

Process for Producing a Coated Metal Alloy Substrate

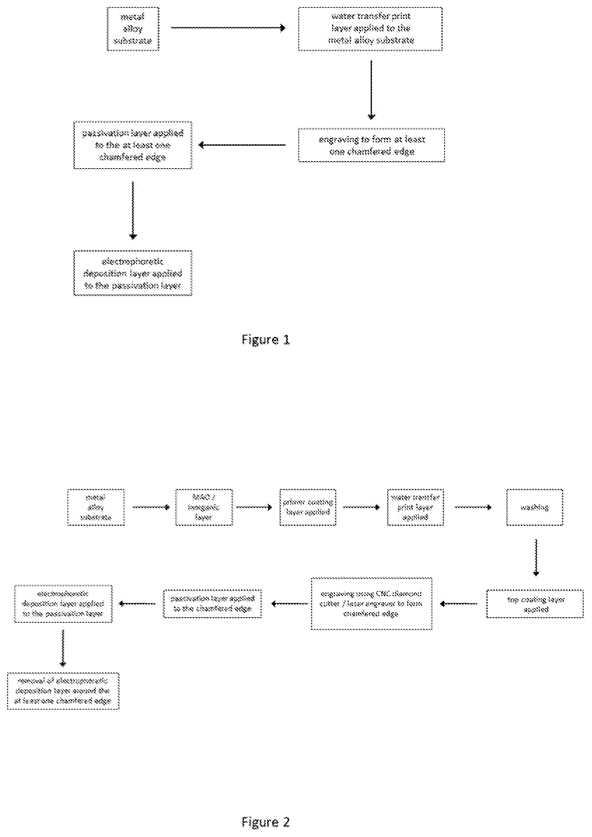

The present disclosure also relates to a process for producing a coated metal alloy substrate disclosed herein. The process for producing a coated metal alloy is described below and shown in the flow chart in FIG. 1.

In some examples there is provided a process for producing a coated metal alloy substrate for an electronic device comprising: applying a water transfer print layer to the metal alloy substrate; engraving the metal alloy substrate to form at least one chamfered edge; applying a passivation layer to the at least one chamfered edge; and applying an electrophoretic deposition layer to the passivation layer.

The metal alloy substrate is coated with a water transfer print layer. To transfer the image onto an object, the water transfer print film is placed on the surface of a volume of water. An activator comprising organic solvent may be applied over the water transfer print film to initiate dissolution of the water-soluble film. As the water-soluble film dissolves, the printed image remains on the surface of the water. When an object is immersed into the water, the printed image contacts and adheres to the substrate as a water transfer print layer. The surface tension of the water allows the printed image to form around objects having a variety of shapes including, for example, objects having contoured, curved, raised or recessed surface features. In this way, the water transfer print layer may adhere well to surfaces with contours and other surface features.

The metal alloy substrate is engraved to form a chamfered edge. The chamfered edge formed by the engraving may be an exposed non-oxidized surface of the substrate. This process removes a part of the coated surface, including, for example, any oxidized layers to expose a shiny surface of the undedlying substrate. Part of the first coated surface of the substrate is retained after the engraving process.

Engraving the metal alloy substrate to form at least one chamfered edge may be carried out to form a predefined pattern or shape. The engraving process may allow the formation of patterns that will provide a surface of the chamfered edge with a texture or finish that is different to the texture or finish of the metal alloy substrate that has not been engraved.

Engraving the metal alloy substrate to form at least one chamfered edge may be carried out using a Computer Numeric Control (CNC) diamond cutter or a laser engraver. Using this process, parts of the metal alloy substrate may be cut away and each resulting chamfered edge may form an edge, a sidewall, a logo, a gap for a click pad, a gap for a fingerprint scanner.

A passivation layer is then deposited at the at least one chamfered edge. The passivation layer may be sprayed, rollered, dipped, or brushed onto the metal alloy surface.

An electrophoretic layer is then deposited on at least part of the passivation layer. To carry out the electrophoretic deposition, the metal alloy substrate is made an electrode of an electrochemical cell. The electrochemical cell also has an inert electrode as the counter electrode and an electrolyte comprising the electrophoretic polymer. A potential difference is applied across the electrodes of the electrochemical cell to deposit the electrophoretic polymer over the coating layer. The electrolyte may have a concentration of from about 1 wt. % to about 25 wt. %, such as from about 5 wt. % to about 20 wt. %, or from about 10 wt. % to about 15 wt,% of the electrophoretic polymer. The polymer, in general, has ionizable groups. When the polymer is a negatively charged material, then it will be deposited on the positively charged electrode (anode). When the polymer is a positively charged material, then it will be deposited on the negatively charged electrode (cathode).

Any excess of the electrophoretic deposition layer around the chamfered edge may be removed. This is due to the electrophoretic deposition layer adhering well to the passivation layer of the chamfered edge, but not adhering well to the water transfer print layer or the top coating layer. In this way, the two surfaces may be processed to result in a dual surface product with good aesthetic properties and a finish having a uniform appearance. In this way, protection may be provided to the areas that are most susceptible to damage.

In one example, as shown in the flow chart of FIG. 2, the metal alloy substrate is treated with MAO to form a micro-arc oxide layer, or an inorganic layer is applied as a non-transparent passivation layer. In this example, the primer coating layer is applied before the deposition of the water transfer print layer. In some cases, especially wherein surface features are of a microscopic and/or nanoscopic scale, the use of a primer coating layer before applying the water transfer print layer may enhance the adhesion of the water transfer print to the metal alloy substrate. Without wishing to be bound by any theory, it is believed that in some cases the surface tension of the water may be unable to bend the printed image around small surface features and imperfections, thus compromising the adherence of the water transfer print layer to the underlying surface. By applying a primer coating layer over the substrate, it may be possible to provide a smoother layer overlying at least part of the substrate. Therefore, when a water transfer print layer is applied over at least part of the primer layer, adhesion may be more effective, as the surface area of contact between the water transfer print layer and underlying surface may be increased.

The surface of the water transfer print layer is then washed with deionized water to remove any impurities such as polyvinyl alcohol adhesive or other impurities before applying a top coat.

The metal alloy substrate is then engraved with CNC laser engraving to form a chamfered edge. The chamfered edge is then treated with a passivation layer and an electrophoretic deposition layer. In this example, in a final step, the extra passivation layer and electrophoretic deposition layer is removed from around the chamfered edge.

In addition to the process shown in the flow chart of FIG. 2, different chamfered edges in different positions of the metal alloy substrate may be engraved and treated separately. For example, the metal alloy substrate may undergo engraving in a first area followed by the deposition of a passivation layer and a first electrophoretic deposition layer on the chamfered edge. This metal alloy substrate may then undergo engraving in a second area followed by the deposition of a passivation layer and a second electrophoretic deposition layer on the chamfered edge. The same metal alloy substrate may then undergo engraving in a third area followed by the deposition of a passivation layer and a third electrophoretic deposition layer on the chamfered edge. Applying such a process leads to a metal alloy substrate with areas with chamfered edges that are treated with a different passivation layer, a different electrophoretic deposition layer or combinations of a different passivation layer and a different electrophoretic deposition layer. For example, the electrophoretic deposition layer may comprise a different colorant for each area. In some examples, the metal alloy substrate has different areas each treated with an electrophoretic deposition layer comprising a different colorant.

In one example, no further coating is applied after treating the chamfered edge with a passivation layer and an electrophoretic deposition layer.

Each layer may be applied to achieve a desired thickness. The thickness of each layer can be measured after it has been applied using, for example, a micrometre screw gauge or scanning electron microscope (SEM).

Electronic Device

The electronic device of the present disclosure may be a computer, a laptop, a tablet, a workstation, a cell phone, a portable networking device, a portable gaming device and a portable GPS.

The electronic device has an electrical circuit, such as a motherboard or display circuitry. The housing may be external to the electrical circuit.

Housing

As described in the present disclosure, an electronic device may have a housing. In some examples there is provided an electronic device having a housing, wherein the housing comprises: a metal alloy substrate with at least one chamfered edge; a water transfer print layer deposited on the metal alloy substrate; a passivation layer deposited on the at least one chamfered edge; and an electrophoretic deposition layer deposited on the passivation layer. The housing comprises a metal alloy substrate disclosed herein.

The metal alloy substrate can be light-weight and may provide a durable housing. The housing of the present disclosure may have cosmetic features that are visually appealing to a user, such as an attractive surface finish and it may have design features with a pleasant texture. The use of a water transfer print layer may also enable a bespoke housing to be formed in a simple and cost-effective manner.

The housing may provide an exterior part of the electronic device, such as a cover or a casing of the electronic device. The housing may include a support structure for an electronic component of the electronic device. The housing may include a battery cover area, a battery door, a vent or combinations thereof.

The housing may provide a substantial part of the cover or the casing of the electronic device. The term “substantial part” in this context refers to at least about 50%, such as at least about 60%, at least about 70%, at least about 80% or at least about 90%, of the total weight of the cover or the casing. The housing may provide the entire cover or casing of the electronic device.

The housing can be a cover, such as a lid, the casing or both the cover and the casing of the electronic device. The casing may form a bottom or lower part of the cover of the electronic device. For example, the housing is the casing of a laptop, a tablet or a cell phone.

The housing may comprise a dual surface metal alloy substrate, wherein the chamfered edge may comprise different coating layers than the main non-engraved surface of the metal alloy substrate. The main non-engraved surface of the metal alloy substrate may provide a bezel for a display screen, a casing, or wrist rest for a keyboard.

The chamfered edge may provide an edge or peripheral area in the housing for a touchpad, a fingerprint scanner, a trackball, a pointing stick, or a button, such as a mouse button or a keyboard button.

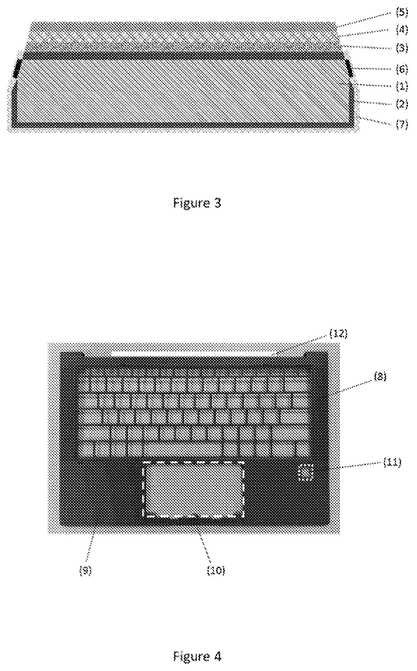

An example of a housing of the present disclosure is shown in FIG. 3, which is a partial cross section through the housing. The housing has a metal alloy substrate (1) with an oxidized layer (2), which may be a micro-arc oxide layer or an inorganic layer. A primer coating layer (3) is deposited on the oxidized layer (2). A water transfer print layer (4) is deposited on the primer coating layer (3). A top coating layer (5) is deposited on the water transfer print layer (4).

The oxidized layer (2), the primer coating layer (3), the water transfer print layer (4) and the top coating layer (5) form a non-engraved coated surface of the metal alloy substrate.

On the chamfered edge of the substrate, a passivation layer (6) is deposited. The passivation layer (6) may be a transparent passivation layer. An electrophoretic deposition layer (7) is then deposited on the passivation layer (6).

FIG. 4 shows an example of a housing of the present disclosure. The housing is a casing (8) for a keyboard of a laptop. The non-engraved coated surface of the metal alloy substrate (9) provides a wrist rest and cover for the laptop. Chamfered edges form further surfaces such as (10), (11) and (12). One of these surfaces, surface (10) was diamond cut from the main casing and forms an edge around a touchpad, surface (11) was also diamond cut from the main casing and provides an edge around a fingerprint scanner, and surface (12) is a CNC diamond cut across the sidewall of the laptop housing. Each of the chamfered surfaces (10), (11) and (12) may be a different colour. In this example, surface (10) is white, surface (11) is yellow and surface (12) is red. The surfaces have an attractive appearance and provide a pleasant tactile surface. Along with a high metallic lustre, the surfaces are corrosion resistant and have a durable coating.

### EXAMPLES

The following illustrates examples of the methods and other aspects described herein. Thus, these Examples should not be considered as limitations of the present disclosure, but are merely in place to teach how to make examples of the present disclosure.

### Example 1

A keyboard casing for a laptop was manufactured from a magnesium alloy substrate comprising the magnesium alloy AZ31B, which comprises, based on the weight of the total alloy: Al: 2.5-3.5 wt. %, Zn: 0.6-1.4 wt. %, Mn: 0.2 wt. %, Si: 0-1 wt. %, Cu: 0.05 wt %. Ca: 0.04 wt. %, Fe: 0.005 wt. %, Ni: 0.005 wt. % and the remainder being Mg and inevitable impurities.

An oxidized surface layer was formed on the magnesium alloy substrate by micro-arc oxidation. The oxidized surface layer was then coated with a primer coating layer of polyurethane polyester.

A water transfer printed film comprising polyvinyl alcohol was then placed in water and treated with an activating spray of xylene. The image from the water transfer printed film was then transferred to the surface of the metal alloy substrate by immersing the substrate into the water with the water transfer print image to form a water transfer print layer.

The surface of the water transfer print layer was then cleaned by deionized water before applying UV top coating layer of urethane acrylate. The top layer was exposed to UV light at 700 mJ/cm³ for 20 seconds. The combination of the micro-arc oxidation layer, the primer coating layer, the water transfer print layer and the UV top coating layer formed a non-engraved coated surface of the metal alloy substrate.

Chamfered edges were then cut into a first area of the coated metal alloy substrate by using a CNC cutting process to expose a non-oxidised surface of the coated metal alloy substrate to cut an opening in the casing for a touchpad.

The shiny, exposed chamfered edges of the substrate were then coated with a solution comprising a chelated metal complex where the chelating agent is DTTPH and the metal ion is zinc. The solution was dried and formed a transparent passivation layer that protects the underlying metallic surface of the substrate and prevents it from undergoing atmospheric oxidation.

Using electrophoretic deposition, the electrophoretic polymer, which was a polyacrylic polymer comprising Pigment Red 168 MF was applied onto the transparent passivation layer to form a coloured coating layer. The substrate was then heated at 170° C. for 45 minutes. Excess passivation layer and electrophoretic deposition layer around the chamfered edges was then removed.

Further chamfered edges were then cut into a second area of the coated metal alloy substrate by using a CNC cutting process to expose a non-oxidised surface of the coated metal alloy substrate to cut an opening in the casing for a fingerprint scanner.

The shiny, exposed chamfered edges of the substrate were then coated with a solution comprising a chelated metal complex where the chelating agent is DTTPH and the metal ion is zinc. The solution was dried and formed a transparent passivation layer that protects the underlying metallic surface of the substrate and prevents it from undergoing atmospheric oxidation.

Using electrophoretic deposition, the electrophoretic polymer, which was a polyacrylic polymer comprising Pigment Yellow 191 was applied onto the transparent passivation layer to form a coloured coating layer. The substrate was then heated at 170° C. for 45 minutes. Excess passivation layer and electrophoretic deposition layer around the chamfered edges was then removed.

The magnesium alloy substrate exhibited an attractive metallic lustre. An individually chosen print image can be present on the substrate. In addition different areas of the substrate comprising chamfered edges can have different colours, which are likewise individually chosen. The magnesium alloy substrate was found to exhibit corrosion resistance properties in al parts of the substrate including the chamfered edges.

1. A coated metal alloy substrate for an electronic device, wherein the coated metal alloy substrate comprises at least one chamfered edge and comprises:
a water transfer print layer deposited on the metal alloy substrate;
a passivation layer deposited on the at least one chamfered edge; and
an electrophoretic deposition layer deposited on the passivation layer.

2. The coated metal alloy substrate according to claim 1, wherein the water transfer print layer comprises a printed image.

3. The coated metal alloy substrate according to claim 1, wherein the passivation layer is a transparent passivation layer comprising a chelating agent and a metal ion or chelated metal complex thereof.

4. The coated metal alloy substrate according to claim 3, wherein the chelating agent is selected from ethylenediaminetetraacetic acid, ethylenediamine, nitrilotriacetic acid, diethylenetriaminepenta(methylenephosphonic acid), nitrilotris(methylenephosphonic acid), 1-hydroxyethane-1,1-diphosphonic acid and phosphoric acid, and the metal ion is selected from an aluminium ion, a nickel ion, a chromium ion, a tin ion, an indium ion, and a zinc ion.

5. The coated metal alloy substrate according to claim 1, wherein the electrophoretic deposition layer comprises an electrophoretic polymer selected from polyacrylic polymer, polyacrylamide-acrylic copolymer and epoxy-containing polymer.

6. The coated metal alloy substrate according to claim 1, wherein the electrophoretic deposition layer comprises a colorant.

7. The coated metal alloy substrate according to claim 1, wherein the metal alloy substrate comprises a metal alloy selected from an aluminium alloy, a magnesium alloy, a lithium alloy, a titanium alloy and stain steel.

8. The coated metal alloy substrate according to claim 1, wherein the metal alloy substrate is an insert molded metal substrate comprising a plastic insert.

9. The coated metal alloy substrate according to claim 1, wherein the electronic device is selected from a computer, a laptop, a tablet, a cell phone, a portable networking device, a portable gaming device and a portable GPS.

10. A process for producing a coated metal alloy substrate for an electronic device comprising:
applying a water transfer print layer to the metal alloy substrate;
engraving the metal alloy substrate to form at least one chamfered edge;
applying a passivation layer to the at least one chamfered edge; and
applying an electrophoretic deposition layer to the passivation layer.

11. The process according to claim 10, wherein engraving the metal alloy substrate is carried out using a CNC diamond cutter or a laser engraver.

12. The process according to claim 10, wherein a first electrophoretic deposition layer comprising a first colorant is applied to part of the passivation layer, and a second electrophoretic deposition layer comprising a second colorant is applied to a further part of the passivation layer.

13. The process according to claim 10, wherein the metal alloy substrate is treated with micro-arc oxidation or passivated before applying the water transfer print layer.

14. The process according to claim 10, wherein a primer coating layer is applied to the metal alloy substrate before applying the water transfer print layer.

15. An electronic device having a housing, wherein the housing comprises:
a metal alloy substrate with at least one chamfered edge;
a water transfer print layer deposited on the metal alloy substrate;
a passivation layer deposited on the at least one chamfered edge; and
an electrophoretic deposition layer deposited on the passivation layer.
